(19) United States
(12) Patent Application Publication
(10) Pub. No.: US 2008/0079308 A1
(43) Pub. Date: Apr. 3, 2008

(54) AUTOMOTIVE AXLE HOUSING AND METHOD OF MAKING SAME

(75) Inventor: Stephen Kretschmer, Oakland, MI (US)

Correspondence Address: GIFFORD, KRASS, SPRINKLE,ANDERSON & CITKOWSKI, P.C, PO BOX 7021, TROY, MI, 48007-7021, US

(73) Assignee: Martinrea Industries, Inc., Manchester, MI (US)

(21) Appl. No.: 11/862,688

(22) Filed: Sep. 27, 2007

Related U.S. Application Data
(60) Provisional application No. 60/827,479, filed on Sep. 29, 2006.

(51) Int. Cl. B60B 35/00

(52) U.S. Cl. 301/124.1

(57) ABSTRACT

An automotive axle housing having a center housing with two aligned side openings. A pair of axle tubes is secured to the center housing so that the axle tubes are aligned with the center housing side openings on opposite sides of the center housing. A pair of wheel bearing assemblies is then secured to the outer or free end of each axle tube.

### CROSS-REFERENCE TO RELATED APPLICATIONS

This application claims priority of U.S. Provisional Patent Application Ser. No. 60/827,479 filed Sep. 29, 2006, which is incorporated herein by reference.

### BACKGROUND OF THE INVENTION

I. Field of the Invention

The present invention relates generally to an automotive axle housing and a method for making the axle housing.

II. Description of Related Art

Essentially all rear wheel drive automotive vehicles include an axle housing for the rear drive wheels. Typically, the axle housing is formed from an upper shell which is secured to a lower shell by welding. The upper shell and lower shell include a center housing portion adapted to be secured to the differential for the automotive vehicle. The remainder of the shells are secured together to form the axle enclosures. The housing shells are welded together and, similarly, a wheel bearing support is secured to the free end of each axle enclosure.

Since the upper and lower housings are each made as one piece, the thickness used is determined by the highest stresses seen in service. This generally results in an unnecessary weight of material elsewhere. Additionally, the upper and lower stamping configuration generally results in poor material utilization in the stamping process as well as the need to use larger more costly forming presses.

In order to control the movement of lubricating oil within the housing thin metal baffles are typically installed in the outer portion of the center portion of the housing. The oil control baffles are typically welded in position or snapped into retaining clips which are welded in the proper location.

In order to attain sufficient rigidity for the axle housing, as well as to seal the axle housing against lubricant leakage, these previously known axle housings have included numerous gusset plates which are also secured to the axle housing assembly.

After the upper and lower shells of the axle housing have been welded together, it is necessary to machine both the rear and forward face of the center housing portion. Such machining is necessary to obtain a flat surface for a fluid-tight attachment of a rear covering to the axle central portion. Similarly, the front of the axle housing central portion must also be machined in preparation for securing a differential attachment ring to the axle housing. This ring is typically welded to the axle housing and provides the necessary attachment points for securing the axle housing to the automotive vehicle differential. The bearing supports are then welded to the housing. The bearing supports are typically attached in a rough machined condition.

As a result of the long upper and lower housing configuration and the need to have gussets, a separate front ring along with a separate rear cover, a large amount of welding is necessary to produce the finished assembly. The large amount of welding results in a greater possibility of leakage and increased distortion both of which must be remedied by costly added manufacturing operations.

After the entire axle housing has been assembled and welded together, the bearing supports and differential attachment ring are oftentimes not precisely aligned with each other due to distortion caused by the various welding operations to form the axle housing. In order to correct this, the axle housing is mechanically bent in an effort to return the housing to within acceptable specifications in preparation for final machining. This final machining is necessary to achieve the finished axle dimensional requirements.

The construction of the previously known axle housings thus suffers from numerous disadvantages. First, the previous axle housings required numerous components which must not only be properly positioned relative to each other, but secured together, typically by welding. This, of course, adds additional expense to the manufacturing expense of the axle housing.

A still further disadvantage of the previously known axle housings is that such axle housings required numerous machining operations, such as machining the front and rear face of the central portion of the axle housing and final machining of the bearing supports, in order to complete the construction of the axle housing. These machining operations are not only costly, but also time consuming to perform.

### SUMMARY OF THE PRESENT INVENTION

The present invention provides an axle housing assembly, and method for making the same, which overcomes the above-mentioned disadvantages of the previously known devices.

In brief, the axle housing of the present invention comprises a center housing having two aligned side openings. The center housing is constructed from a front and rear metal stamping and two structural oil control baffles which are used for local stress reduction as well as for the control of the lubricating oil. The front and rear stampings being smaller than the conventional upper and lower stampings typically have better material utilization, and can be produced in smaller more cost effective forming presses. These parts are secured together by welding. Such welding may be conventional welding or, in the case of other materials such as aluminum, by friction stir welding. The front stamping is formed with a sufficiently flat front face for the mounting and sealing of the differential. The rear stamping is formed with a bulge in order to provide clearance for the differential and thus eliminates the separate cover necessary in the conventional construction. Mounting holes or, alternatively, mounting studs are attached to the center housing for securing the center housing, and thus the axle housing, to the automotive vehicle differential. In the event that threaded holes are necessary to mount the axle housing to the differential, threaded bosses are attached in alignment with holes formed through the front of the center housing during the stamping operation to form the center housing front shell. Alternatively, threaded studs are press fit through holes in the center housing and preferably sealed to the center housing by O-rings. The threaded bosses or studs are installed prior to welding the front and rear stampings together.

A pair of elongated tubes, each having an outwardly flared inner end, is then secured to the center housing. The outwardly flared portion of each tube is dimensioned to flatly abut against either an inner surface or outer surface of the center housing and so that the tubes are aligned with the side openings on the center housing as well as aligned with each other. When property positioned, the tubes are welded to the center housing by conventional welding or other welding techniques, such as friction stir welding. The outwardly flared tubes create a larger joint with the center housing than would otherwise be possible thus reducing the local stresses.

The use of two tubes in conjunction with front and rear center housing stampings allows the use of different metal thicknesses and/or alloys which are selected based on the local structural requirements. This results in lower weight and less cost. In addition, this combination results in less welding and thus reduced weld induced distortion and less cost.

The outwardly flared end of each tube is preferably formed by hydroforming. Optionally, however, the outwardly flared portion may be formed by a piston and ram flaring operation.

After the tubes are connected to the center housing, a finish machined wheel bearing support is secured to the outer free end of each tube. The wheel bearing support is conventional in construction and may be either semi-floating for light duty vehicles, or full floating for heavier duty vehicles.

In the event that the bearing supports and the differential mounting surface of the front stamping are misaligned, such a misalignment may be corrected by local heating of the tube in an amount sufficient to thermally deform the tube to return the tube to within acceptable specifications.

The present invention thus provides an automotive axle housing which is constructed without the necessity of machining the axle housing during its manufacture.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which.

FIG. 1 is an elevation view illustrating one embodiment of the axle housing of the present invention;

FIG. 2 is an exploded perspective view of the embodiment of the axle housing illustrated in FIG. 1;

FIG. 3 is a view illustrating the formation of the axle tubes;

FIG. 4 is a view illustrating a modification of the formation of the axle tubes;

FIG. 5 is an elevation view illustrating a second preferred embodiment of the present invention;

FIGS. 6A-6D are diagrammatic views illustrating the correction of distortion of the present invention;

FIG. 7 is an elevation view illustrating a mounting stud for the differential of the present invention;

FIG. 8 is a side elevation view illustrating a mounting stud for the differential;

FIG. 9 is a fragmentary sectional view illustrating a threaded hole for the lubricant fill and drain holes; and

FIG. 10 is a view similar to FIG. 9 but illustrating a modification thereof.

### DETAILED DESCRIPTION OF PREFERRED EMBODIMENTS OF TEE PRESENT INVENTION

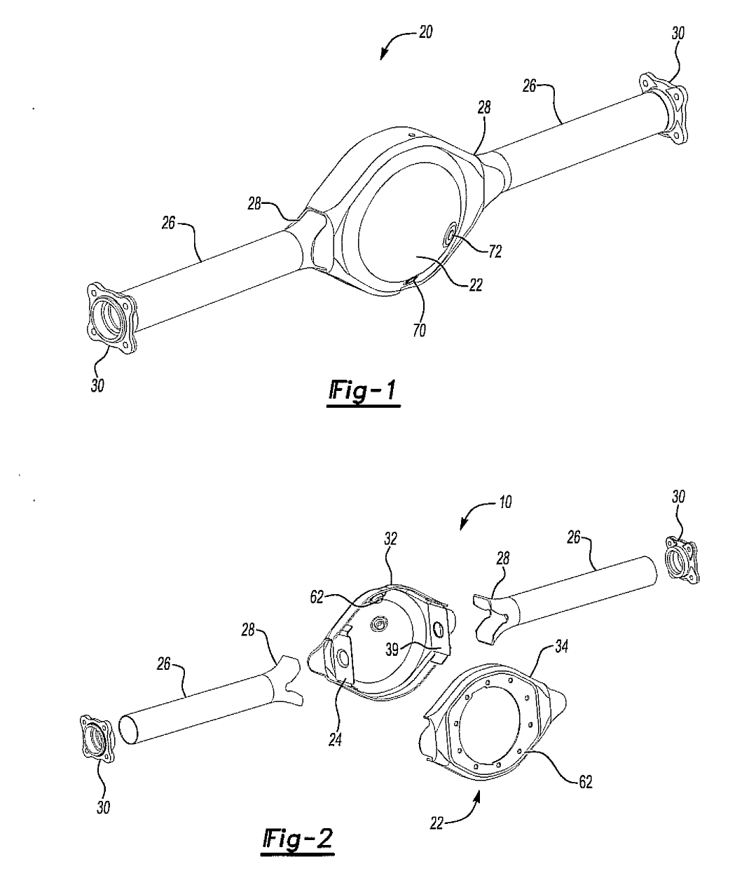

With reference first to FIGS. 1 and 27 a preferred embodiment of an axle housing 20 is shown for use with a rear drive automotive vehicle. The axle housing 20 includes a center housing 22 having a pair of opposed side openings 24. An elongated tube 26 has one end secured to the center housing 22 so that the tubes 26 are not only aligned with the openings 24, but aligned with each other and extending out opposite sides of the center housing 22. A wheel bearing support 30 is secured to the outer or free end of each tube 26 in a manner that will subsequently be described in greater detail.

With reference now particularly to FIG. 2, the center housing 22 comprises a rear shell 32 and a front shell 34 which abut together and are secured together by welding. These shells 32 and 34 are preferably formed by stamping and are welded together in any conventional fashion, such as conventional MIG welding for steel or aluminum or alternatively, friction stir welding for aluminum.

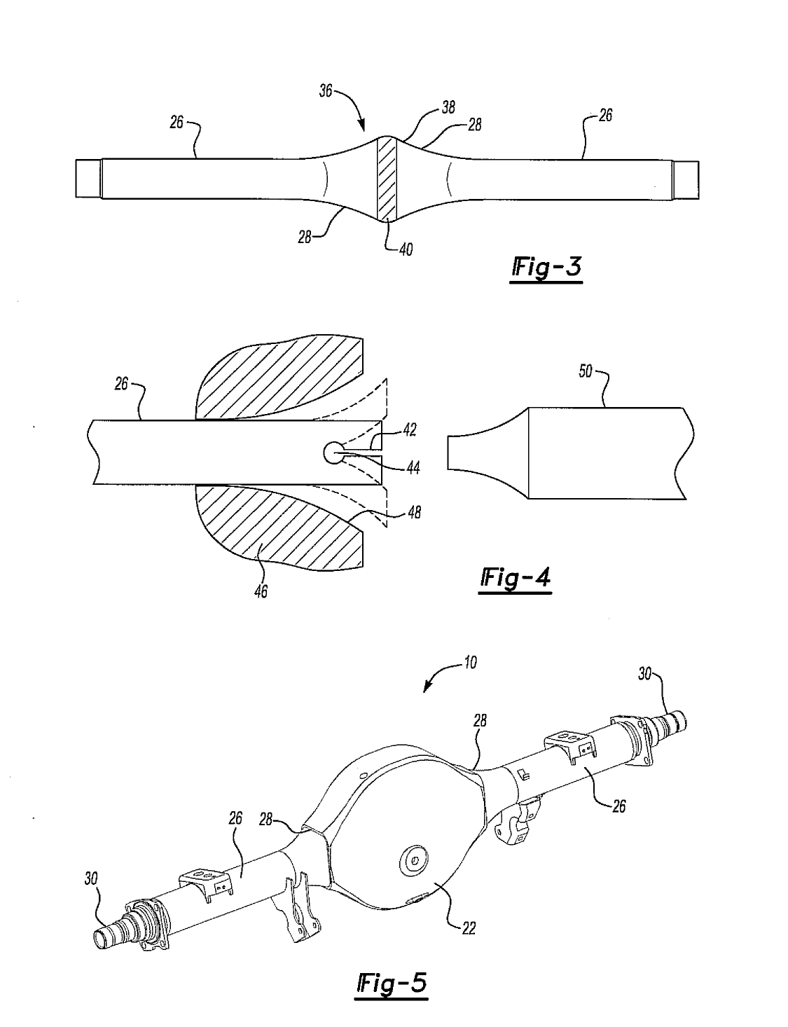

With reference now to FIGS. 2 and 3, each tube 26 includes an outwardly flared portion 28 at its inner end. This outwardly flared portion 28, furthermore, may be formed in any of several different fashions.

For example, as shown in FIG. 3, an elongated tube 36 may be subjected to hydroforming thus forming a large bulge 38 in the center of the tube 36. After forming, the bulge 38 is cut along a line 40 thus forming two tubes, each having the outwardly flared portion 28 at one end.

With reference now to FIG. 4, a still further method of forming the outwardly flared portion 28 on the tubes 26 is shown. In this embodiment, an elongated slit 42 and relief opening 44 are formed on one end of the tube 26. The tube 26 is then constrained within a tool 46 having an opening 48 which conforms to the shape of the desired flared portion 28 of the tube 26. A ram 50 is then mechanically driven into the end of the tube 26 thus flaring the end of the tube 26 outwardly against the tool holder 46 and forming the outwardly flared portion 28 as shown in phantom line.

Referring again to FIG. 1, in order to secure the tubes 26 to the center housing 22, the tubes 26 may be aligned with the center housing 22 so that the outwardly flared portion 28 of each tube 26 abuts against an outer surface of the center housing 22. The outwardly flared portions 28 of the tubes 26 are then welded to the center housing 22 using any conventional welding process that is acceptable to the type of material used for the axle housing.

Oil baffles 39 may also be secured to the center housing 22. These oil baffles 39 not only add structural support for the center housing 22, but also facilitate the final assembly of the axle.

Alternatively, the tubes 26 may be arranged so that the outwardly flared portions 28 of the tubes 26 abut against an inner surface of the center housing 22. In this event, the outwardly flared ends 28 of the tubes 26 are positioned in between the rear shell 32 and front shell 34 of the center housing 22 when the shells 32 and 34 are secured together. Thereafter, the tubes 26 are slid outwardly until the outwardly flared ends abut against inner surfaces of the center housing 22 whereupon these ends 28 are welded to the center housing 22.

In some situations, one or both of the tubes 26 may have deformed slightly due to the welding operations performed to attach the tubes 26 to the center housing 22 and such deformation is outside acceptable limits for friction welding the bearing supports in proper alignment with the front face of stamping 22. In that event, the tubes 26 are bent as described below to return the alignment of the outer ends of the tubes and the front face of the center housing 34 to acceptable specifications.

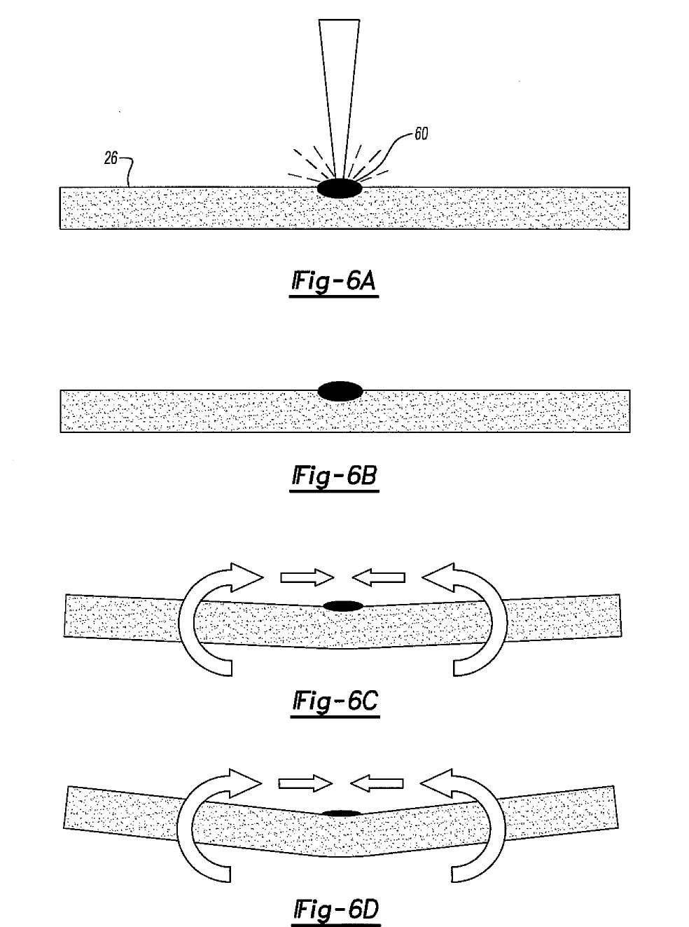

With reference then to FIG. 6, in order to bend one or both of the tubes 26 to acceptable specifications, localized heat 60 is applied to the tube 26 as shown in FIG. 6A. The heated tube 26 then shrinks from the position shown in FIG. 6B to the position shown in FIG. 6C and finally to the position shown in FIG. 6D in order to bend the tube 26 as required to return the alignment of the wheel bearing assemblies 30. Any means, such as a laser, MIG welding torch, inductive heating, etc., may be used to heat the tube.

With reference now to FIGS. 2 and 5, after the tubes 26 have been secured to the center housing 22, either on the outer surface of the center housing 22 as shown in FIGS. 1 and 2, or the inner surface as illustrated in FIG. 5, the wheel bearing supports 30 are secured to the outer free ends of the tubes 26. These wheel bearing supports, furthermore, may be either the semi-floating type as illustrated in FIGS. 1 and 2 for lighter duty automotive vehicles, or the full floating type illustrated in FIG. 5 for heavier duty vehicles.

Although any conventional means may be utilized to secure the wheel bearing supports 30 to the ends of the tubes 26, preferably the wheel bearing supports 30 are attached to the tubes 26 by friction welding. In friction welding, the tubes 26 and center housing 22 are mounted in a jig while the wheel bearing supports 30 are rotatably spun and pressed onto the ends of the tubes 26. The resulting friction between the wheel bearing supports 30 and the tubes 26 then forms the weld.

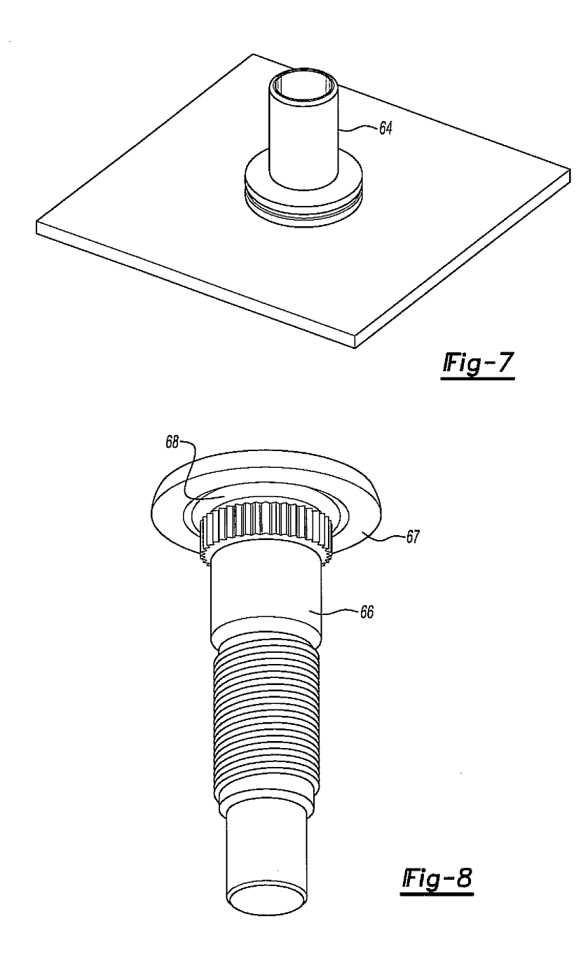

With reference now to FIGS. 2 and 7, in one type of axle housing 20, a plurality of openings 62 are provided around the front shell 34 of the center housing 22 for attaching the center housing 22 to the differential for the automotive vehicle. Such an attachment is typically performed by threaded fasteners.

Since the stamping used to form the front shell 34 of the center housing 22 is relatively thin and cannot provide sufficient thread length, an internally threaded boss 64 is preferably welded to each of the openings 62 formed during the stamping process of the front shell 34. Any conventional means, such as conductive heat-resistant welding, deformation resistance welding, or mechanical clinching may be used to secure the threaded bosses 64 to the front shell 34. In other types of axle housings 20, it is desirable to have a plurality of outwardly extending threaded studs extending outwardly from the front shell 34 of the center housing 22 for attaching the axle housing 20 to the differential. Consequently, in this situation an externally threaded stud 66, such as shown in FIG. 8, may be press fit into each opening 62 in the front shell 34 of the center housing 22. In order to assure a fluid-tight fit, an O-ring 68 is preferably mounted within a recess 67 in the stud 66. Consequently, once the stud 66 is press fit through the shell opening 62, the O-ring 68 flatly abuts against the shell 34 of the center housing 22 and forms a fluid-tight fit.

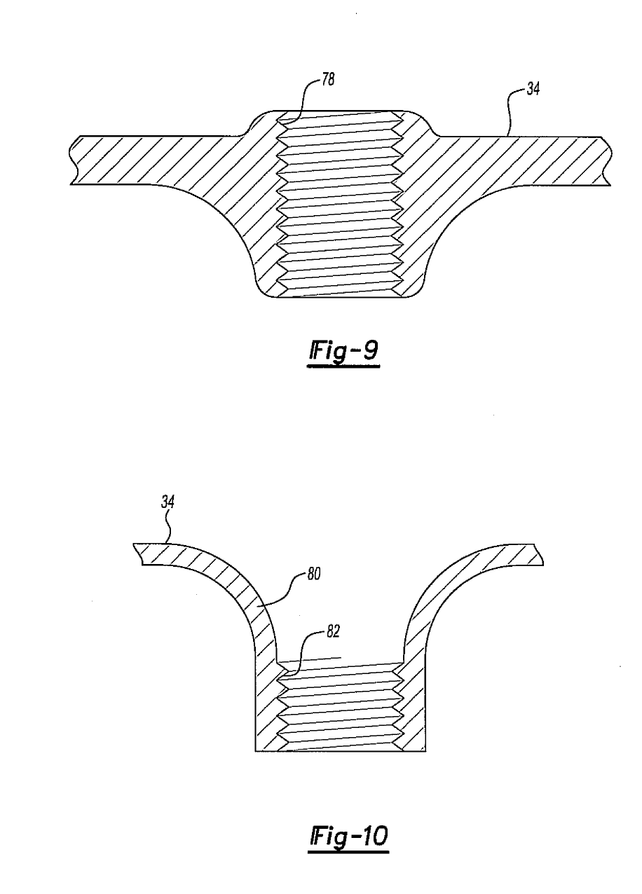

With reference now to FIGS. 1 and 9, a drain opening 70 and lubricant fill opening 72 are typically formed through the rear shell 32 of the center housing 22. Both openings 70 and 72 must be sealed during normal use of the axle housing 20 to prevent leakage from the axle housing 20.

Although different means may be employed to form the fill and drain openings 72 and 70, respectively, as best shown in FIG. 9, an opening 76 is preferably formed through the opening by flow drilling and then internally threaded as shown at 78. Flow drilling provides a relatively long area of contact from the relatively thin stamping used to construct the rear shell of the center housing and thus ensures a good seal between a subsequent plug (not shown) and the rear shell 34.

Alternatively, as shown in FIG. 10, holes 80 may be formed in the rear shell 34 of the center housing 22 and then internally threaded as shown at 82 for the lubricant fill and drain openings. Still other means may be used to form the lubricant fill and drain holes without deviation from the spirit or scope of the present invention.

From the foregoing, it can be seen that the present invention provides a novel axle housing and method for making the axle housing which overcomes a number of disadvantages suffered by the previously known axle housings. Specifically, the present invention completely eliminates the need for machining the axle housing during its manufacture. In particular, it is no longer necessary to machine the front of the center housing for the axle housing in order to create a flat surface for mounting the center housing to the vehicle differential. Instead, the flat surface formed during the stamping operation for the front shell 34 of the center housing 22 is sufficiently flat to mate against the differential without further machining.

Similarly, the present invention avoids the necessity of machining a flat surface on the rear of the center housing in preparation for attaching a rear cover to the center housing Previously, such a machined surface was required in order to assure a leak-free attachment between the rear cover and the center housing. Such machining is avoided by the present invention by simply forming the center housing from two stamped shells.

In addition the use of pre-machined bearing supports which are welded in proper alignment to the outboard ends of the tubes and the front face of the center housing eliminates the need to machine them as a part of the complete axle assembly thus avoiding a costly investment in special purpose machining centers.

The present invention also provides a unique manner to correct by heat treatment distortion which occurred during the manufacture of the axle housing. Such correction of distortion is not only less expensive and more rapid than the previously known mechanical bending to correct for such distortions, but also more accurate.

Additionally, as a result of the unique construction the present invention results in lower weight reduced welding and improved utilization of materials.

Having described my invention, however, many modifications thereto will become apparent to those skilled in the art to which it pertains without deviation from the spirit of the invention as defined by the scope of the appended claims.

I claim:

1. An automotive axle housing comprising
a center housing having two aligned side openings,
a pair of axle tubes, each tube having one end secured to said center housing so that said axle tubes are aligned with said center housing side openings,
a pair of wheel bearing supports, one wheel bearing support secured to the outer end of each tube, and
a pair of oil control baffles secured to the inside of said center housing near said two aligned side openings.

2. The invention as defined in claim 1 wherein said one end of each axle is welded to an outer surface of said center housing.

3. The invention as defined in claim 1 wherein said one end of each axle is welded to an inner surface of said center housing.

4. The invention as defined in claim 1 wherein said one end of each tube comprises an outwardly flared portion.

5. The invention as defined in claim 4 wherein said outwardly flared portion is formed by hydroforming.

6. The invention as defined in claim 1 wherein each tube is a one-piece tube.

7. The invention as defined in claim 1 wherein said center housing comprises a front housing shell and a rear housing shell, said housing shells being fixedly secured together.

8. The invention as defined in claim 7 wherein each housing shell comprises a stamping.

9. A method of constructing an axle housing comprising the steps of:
assembling a center housing having two side aligned openings,
attaching an axle tube to each opening so that said axle tubes are aligned with each other,
securing a wheel bearing support to a free end of each tube.

10. The invention as defined in claim 9 wherein said assembling step comprises the steps of stamping a front housing shell and a rear housing shell, and welding said housing shells together.

11. The invention as defined in claim 10 wherein said welding step comprises friction stir welding.

12. The invention as defined in claim 9 wherein said attaching step comprises the step of welding an end of each said tube to said center housing so that said tubes are aligned with each other and extend outwardly from opposite sides of the center housing.

13. The invention as defined in claim 12 wherein said welding step comprises the step of friction stir welding the tube to the housing.

14. The invention as defined in claim 9 wherein said securing step comprises the step of friction welding the wheel bearing supports to the free end of each tube.

15. The invention as defined in claim 9 and comprising the step of correcting misalignment of said tubes by heating selected portions of one or both of said tubes.

16. The invention as defined in claim 15 wherein said heating step comprises laser heating for a time sufficient to correct said misalignment.

17. The invention as defined in claim 15 wherein said heating step comprises heating with a MIG welding torch.

18. The invention as defined in claim 15 wherein said heating step comprises heating with a TIG welding torch.

19. The invention as defined in claim 15 wherein said heating step comprises induction heating.

20. The invention as defined in claim 9 and comprising the step of attaching a plurality of threaded bosses to said center housing.

21. The invention as defined in claim 9 and comprising the step of attaching a plurality of threaded studs to said center housing.

22. The invention as defined in claim 19 wherein said plurality of threaded studs includes sealing rings.

23. The invention as defined in claim 9 and comprising the step of forming a plurality of threaded bores in the center housing by flow drilling and tapping holes in the center housing.

24. The invention defined in claim 1 wherein said oil control baffles act as structural reinforcements.
